(19) United States
(12) Patent Application Publication
(10) Pub. No.: US 2026/0016230 A1
(43) Pub. Date: Jan. 15, 2026

(54) METHOD FOR SETTING AN OVEN ATMOSPHERE IN A HEAT-TREATMENT OVEN

(71) Applicant: ThyssenKrupp Steel Europe AG, Duisburg (DE)

(72) Inventors: Daniel SCHUBERT, Duisburg (DE); Nils JÄGER, Mulheim (DE); Martin KORNER, Oberhausen (DE)

(73) Assignee: ThyssenKrupp Steel Europe AG, Duisburg (DE)

(21) Appl. No.: 18/993,812

(22) PCT Filed: Jul. 20, 2023
(86) PCT No.: PCT/DE2023/100535

§ 371 Date: Jan. 13, 2025

(30) Foreign Application Priority Data
Jul. 21, 2022 (DE) 10 1022 118 249.5

(51) Int. Cl. F27D 7/02; C21D 9/00; F27D 17/17; F27D 99/00

(52) U.S. Cl. CPC F27D 7/02; C21D 9/0006; F27D 17/17; F27D 99/0001; C21D 2241/00

(57) ABSTRACT

A method of establishing a furnace atmosphere in a directly heated heat treatment furnace is provided. A heat treatment furnace has at least one burner which is operated with a fuel gas and an oxygenous gas that are combusted to give a combustion gas. The combustion gas has a defined composition having a defined partial water vapor pressure. Hydrogen is used in the fuel gas with a proportion of at least 10% by volume. The heat treatment furnace is additionally flooded with a water vapor-free and/or hydrogen-free gas, as a result of which the water vapor-free and/or hydrogen-free gas mixes with the combustion gas so as to bring about a partial water vapor pressure of the mixture in the furnace atmosphere of the heat treatment furnace that is less than the defined partial water vapor pressure of the combustion gas.

The invention relates to a method of establishing a furnace atmosphere in a directly heated heat treatment furnace.

Heat treatment furnaces, for example directly heated furnaces (direct fired furnaces, also called DFFs), are furnaces in established practical use that are used for heat treatment of metals. These are fed in a standard manner with fossil fuels, for example natural gas. Since the combustion takes place in the furnace, it is possible with the aid of direct heating, depending on the air ratio established (lambda value of the fuel gas), to establish a reducing or oxidizing furnace atmosphere. What is thus present in the furnace is the combustion gas for the burners, containing a high proportion of water and, depending on the air ratio, oxygen (O₂) and carbon dioxide (CO₂) or hydrogen (H₂) and carbon monoxide/carbon dioxide (CO/CO₂).

In the context of the global requirement for decarbonization, plants operated with fossil fuels are to be retrofitted or converted in the future for more environmentally friendly fuels or energy carriers, for example hydrogen, in order thus to reduce or ultimately avoid the use of fossil energy.

Decarbonization requires a reduction in the use of fossil feedstocks or energy carriers, and hence in turn an associated reduction in CO₂ output.

A conversion particularly in the case of a heat treatment of metals in the directly heated furnace would result in a new furnace atmosphere with very influential parameters with regard to the physical properties to be achieved at a later stage in the end product or intermediate product of the heat-treated metal. Thus, if a heat treatment furnace, with regard to its fossil fuel (natural gas), were to be converted to an alternative, hydrogen-containing fuel, this has major effects on the atmosphere in the combustion of these fuels and hence also on the metals to be heat-treated or the surface(s) thereof. In the combustion of the hydrogen-containing fuels, a greater amount of water vapor is generated compared to natural gas, which ensures that a higher partial water vapor pressure would exist in the furnace atmosphere. This has the result that there is a greater tendency to oxidation (scale formation) during heat treatment by virtue of elements having oxygen affinity in the metal, which forms in particular at the surface of the metal. The existence of a higher partial water vapor pressure affects the bond between scale and metal surface, or in simplified terms adhesion on the metal surface.

In particular, steel (as a metal) is very sensitive to any increase in partial water vapor pressure in furnace atmospheres in heat treatments. This may also promote unwanted introduction of hydrogen into the steel, leading to problems in high-strength steels inter alia, which is known as “delayed fracture”.

For instance, heat treatment of a steel in a 100% water vapor atmosphere can reduce scale on the surface of the steel, such as FeO at a furnace temperature of 1369° C., and Fe₃O₄ or Fe₂O₃ at a furnace temperature of 1539° C. Reduction in the water vapor can cause the adhesion of the scale to increase owing to the movement in the phase fractions, so that it becomes “tackier”. Furthermore, scale formation can be enhanced by the hot water vapor and can proceed in an accelerated manner. Parts of the scale are removable here only with difficulty (about 20-60% [also in an alloy-dependent manner in some cases]), especially the near-substrate scale. The scale layer, by contrast, which lies on the near-substrate scale is very brittle and can be removed even by gentle mechanical action. It may be suspected that the increased partial water vapor pressure results in elevated material loss owing to accelerated scale formation.

Heat treatment of the steel in a water vapor atmosphere allows the grain positions in the structure to be altered, which can lead to unwanted premature grain boundary oxidation, which can in turn cause coating defects and/or surface defects. Because of the increased extent of scale formation, the formation of grain boundary oxidation can likewise proceed more quickly and additionally also penetrate deeper into the substrate.

Heat treatment of a steel in a water vapor atmosphere can also lead to a higher decarburization depth, meaning that the properties of the intermediate product or end product are or have likewise been affected, in particular adversely affected. This may be manifested, for example, in that the mechanical indices are outside the required range and can additionally lead to poorer surface properties or magnetic properties.

Decarbonization in the application case of heat treatment of metals in directly heated furnaces, especially of steels, would thus involve not just a simple change from fossil to nonfossil fuels but also complex influencing of the product parameters.

EP 2 762 599 A1 and EP 3 109 338 A1 disclose, for example, using DFF furnaces in hot dip coating lines for cold steel strips. In addition, DE 10 2011 053 698 B3, for example, discloses using DFF furnaces for austenitization in hot forming lines for press-hardening steels.

It is an object of the present invention to further develop this method, which reduces the use of fossil fuels and does not have the aforementioned drawbacks.

Said object is achieved by a method having the features of claim 1. Further configurations are described in the dependent claims.

The teaching thus relates to a method of establishing a furnace atmosphere in a directly heated heat treatment furnace, where the heat treatment furnace has at least one burner which is operated with a fuel gas and an oxygenous gas that are combusted to give a combustion gas, where, depending on the composition of the fuel gas and the composition of the oxygenous gas and the mixture thereof, the combustion gas has a defined composition having a defined partial water vapor pressure. Essential features of the invention are that hydrogen is used in the fuel gas with a proportion of at least 10% by volume, and the heat treatment furnace is additionally flooded with a water vapor-free and/or hydrogen-free gas, as a result of which the water vapor-free and/or hydrogen-free gas mixes with the combustion gas so as to bring about a partial water vapor pressure of the mixture in the furnace atmosphere of the heat treatment furnace that is less than the defined partial water vapor pressure of the combustion gas.

An increase in the hydrogen in the fuel gas and hence, respectively, an increase in the partial water vapor pressure in the resulting combustion gas has to be counteracted in that the combustion gas is “diluted” by controlled mixing with a water vapor-free and/or hydrogen-free gas, in order to establish a furnace atmosphere in the heat treatment furnace that has a lower partial water vapor pressure compared to the (pure) combustion gas.

In particular, the determination or detection of the partial water vapor pressure is familiar to the person skilled in the art.

By this measure, it is possible to establish a furnace atmosphere that may correspond to the currently known level, with natural gas-fired burners. The hydrogen used in the fuel gas may be generated and provided, for example, in a water electrolysis using renewable energies, such as wind, water and solar. Any oxygen required may likewise be generated and utilized by means of electrolysis by renewable energies (solar, wind, water etc.). The water vapor-free and/or hydrogen-free gas for mixing may contain or consist of dry air, nitrogen (N₂), argon (Ar), carbon dioxide (CO₂) or a mixture thereof. It is also possible to correspondingly use further gases or mixtures of gases that do not contain hydrogen or hydrogen compounds and are suitable for the heat treatment of metals.

The oxygen-containing gas for operation of the burner may be air, for example ambient air, oxygen or a combination of air and oxygen.

In particular, hydrogen may be present in the fuel gas with a proportion of at least 20% by volume.

Preferably, hydrogen may be present in the fuel gas with a proportion of at least 40% by volume.

More preferably, hydrogen may be present in the fuel gas with a proportion of at least 60% by volume.

Especially preferably, hydrogen may be present in the fuel gas with a proportion of at least 80% by volume.

Further preferably, hydrogen may be present in the fuel gas with a proportion of at least 98% by volume. This configuration comprises, for example, 100% use of hydrogen, meaning that the fuel gas consists of hydrogen, with allowance of impurities in the fuel gas at up to 0.5% by volume, especially up to 0.2% by volume, preferably less than 0.1% by volume, given that impurities are avoidable in industry only with a high level of apparatus complexity, if at all.

Unless the fuel gas consists entirely of hydrogen, further proportions of methane (CH₄) and/or carbon monoxide (CO) are present as well as hydrogen, in order to add up to 100% by volume along with impurities, which are allowed at up to 0.5% by volume, especially up to 0.2% by volume, preferably less than 0.1% by volume. Especially in the case of use of natural gas, the proportions of methane may vary and may thus also include further constituents, for example ethane, propane, ethene and butane, individually or in combination.

In order not to adversely affect and/or even to increase the energy of the combustion gas, it may be advantageous when, in one configuration, the water vapor-free and/or hydrogen-free gas is heated prior to flooding of the heat treatment furnace and/or the burner. In order to essentially maintain the energy level of the combustion gas, it is heated to a temperature that preferably corresponds to the temperature of the combustion gas +/−300° C. The temperature may thus correspond to a temperature range between minus and plus 300° C. based on the temperature of the combustion gas. The temperature of the combustion gas may be detected by means known to the person skilled in the art. Preheating of the fuel gas and/or the oxidizing agent may lead to an increase in the adiabatic flame temperature.

In order to be able to economically utilize the offgas removed from the heat treatment furnace, it may be advantageous to use a portion of the offgas, or the entirety, for heating of the hydrogen-free and/or water vapor-free gas. In this case too, the means of offgas utilization or heat transfer are known to the person skilled in the art.

Alternatively or additionally to offgas utilization, (additional) heating can also be conducted by other means, for example electrically, in particular when a higher temperature level compared to the offgas temperature is required.

More preferably, the heat treatment furnace in question here is used for steels or steel alloys in any form, whether as a slab, plate, sheet, strip or (pre) formed sheet metal component. The temperature for the heat treatment is essentially between 200° C. and 1350° C., especially between 400° C. and 1260° C., where this temperature relates to the temperature of the metal to which it is to be heated. The furnace atmosphere temperature or furnace space temperature may quite possibly be higher.

In addition, the temperature of the flame of the burner also affects the temperature of the furnace atmosphere or the temperature of the furnace space. The combustion temperature with ambient air and natural gas is about 1970° C., and with ambient air and hydrogen about 2130° C., and in the case of combustion with oxygen and natural gas about 2860° C., and with oxygen and hydrogen about 3080° C.

In addition, a crucial role is played by the water content (water vapor and hence partial water vapor pressure) in furnace atmospheres for heat treatment of metals. This controls, inter alia, whether the furnace atmosphere has a reducing or oxidizing effect on metals. A standard method known to the person skilled in the art for detecting the water content is called dewpoint determination. The dewpoint of a furnace atmosphere, depending on the application, specifically for steels, may be between −70° C. and +35° C. Negative dewpoints generally suggest a reducing furnace atmosphere.

The invention is elucidated in detail by the working examples that follow, in conjunction with the drawing.

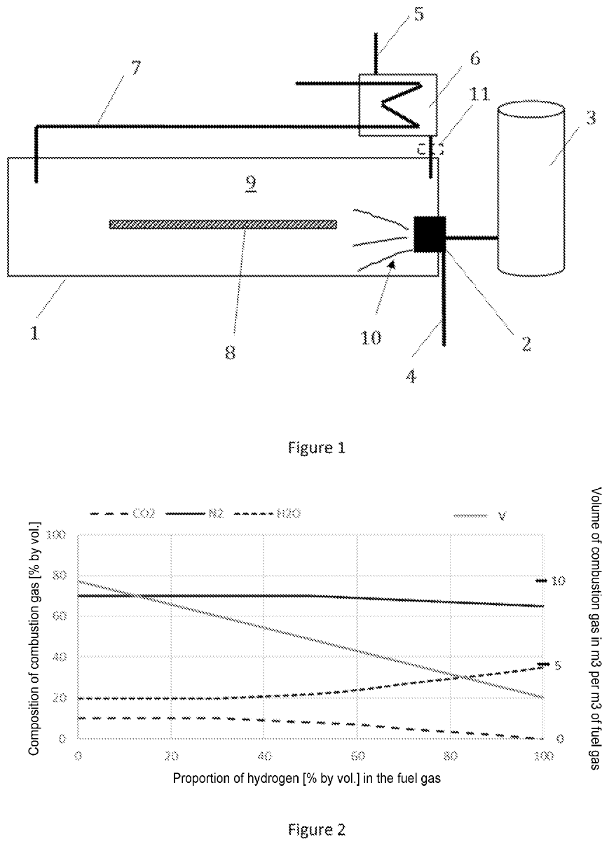

FIG. 1 shows the invention using the example of a schematic illustration. A directly heated heat treatment furnace (1) has at least one burner (2) which is operated with a fuel gas (3) and an oxygenous gas (4) that are combusted to give a combustion gas (10) in the heat treatment furnace (1), where, depending on the composition of the fuel gas (3) and the composition of the oxygenous gas (4) and the mixture thereof, the combustion gas (10) has a defined composition having a defined partial water vapor pressure. Since hydrogen is used in the fuel gas (3) with a proportion of at least 10% by volume, the heat treatment furnace (1) is additionally flooded with a water vapor-free and/or hydrogen-free gas (5), as a result of which the water vapor-free and/or hydrogen-free gas (5) mixes with the combustion gas (10) so as to bring about a partial water vapor pressure of the mixture in the furnace atmosphere (9) of the heat treatment furnace (10) that is less than the defined partial water vapor pressure of the combustion gas (10). Before the flooding of the heat treatment furnace (1), the water vapor-free and/or hydrogen-free gas (5) may be heated. It is possible here to remove an offgas (7) from the heat treatment furnace (1), which can be utilized partly or completely for heating of the hydrogen-free gas (5) by means of a suitable heat carrier (6). Alternatively or additionally, the water vapor-free and/or hydrogen-free gas (5) may be heated, especially additionally, for example by an electrical heating device (11), shown by dashed lines, with which an increase in the temperature of the water vapor-free and/or hydrogen-free gas (5) above the temperature of the combustion gas (10) would also be possible. With the furnace atmosphere (9) established in accordance with the invention, heat treatment of a metal (8), for example a steel, preferably a steel alloy, is possible without the disadvantages of an altered or different scale formation on the surface of the metal/steel (8) in spite of the use of nonfossil fuels, when hydrogen is used with proportions between 10% and 100% by volume in the fuel gas (3).

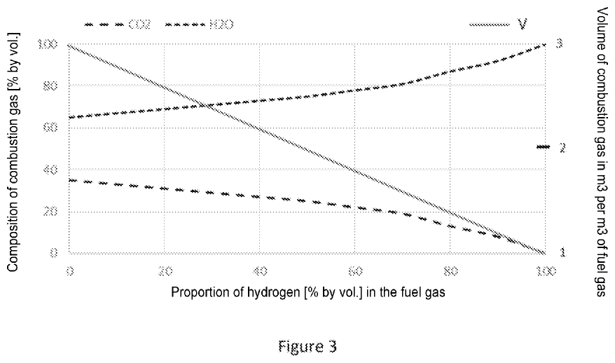

FIGS. 2 and 3 each show a diagram when natural gas is used as fuel, proceeding from about 99% by volume of methane, with a proportion between 0% and 100% by volume of hydrogen (abscissa). On the left there is no hydrogen and 100% by volume of natural gas, whereas on the right there is no natural gas and 100% by volume of hydrogen in the fuel gas. The oxygen-containing gas envisaged for the burner was firstly ambient air (FIG. 2) and secondly oxygen (FIG. 3), considered in the calculation with an air ratio of 1.1.

The diagram also shows the constituents of the combustion gas (left-hand ordinate) against the composition of the fuel gas. On the right-hand ordinate, it is possible to determine the combustion gas volume generated in m³ per m³ of fuel gas used against the composition of the fuel gas.

The results shown in FIGS. 2 and 3 have been ascertained numerically and show the influence of nonfossil fuels, such as hydrogen in the fuel gas, on the composition of the combustion gas.

It is surprising that, when ambient air is used as oxygenous gas for the combustion, lowering of the CO₂ content in the combustion gas is possible only with a hydrogen content of at least 35% by volume in the fuel gas; see FIG. 2. In addition, FIG. 2 shows clearly that a fuel gas consisting of 100% by volume of hydrogen cannot go below a combustion gas volume of 2.5 m³ per m³ of fuel gas (=hydrogen) used.

By contrast, FIG. 3 shows that, in the case of use of oxygen as oxygenous gas for combustion with 100% hydrogen as fuel gas, the volume of the combustion gas corresponds essentially 1:1 to the volume of the fuel gas used. A reduction in the CO₂ content in the combustion gas is also apparent even at relatively low hydrogen contents (less than 35% by volume) in the fuel gas.

Over and above a hydrogen content of 60%, the partial water vapor pressure begins to rise significantly (FIG. 1). In FIG. 2, in the case of combustion of hydrogen with oxygen, the ratio is more extreme. An increasing proportion by volume of hydrogen in the fuel gas ultimately increases the partial water vapor pressure to a maximum level when 100% by volume of hydrogen is used in the fuel gas. If 100% by volume of hydrogen is burned without “dilution” of the furnace atmosphere, this has an adverse effect on the product properties of the metal, such that the water vapor content of the furnace atmosphere can be correspondingly lowered by addition for example of air, for example 20% by volume. This would lead to an improvement in further processing properties. “Dilution” with non-preheated air, for example, would result in a temperature drop, which would remove heating energy that is possibly needed from the metal.

1-9. (canceled)

10. A method of establishing a furnace atmosphere in a directly heated heat treatment furnace, where the heat treatment furnace has at least one burner which is operated with a fuel gas and an oxygenous gas that are combusted to give a combustion gas, where, depending on the composition of the fuel gas and the composition of the oxygenous gas and the mixture thereof, the combustion gas has a defined composition having a defined partial water vapor pressure, the method comprising:
using hydrogen in the fuel gas with a proportion of at least 10% by volume, and
flooding the heat treatment furnace with at least one of a water vapor-free and a hydrogen-free gas, as a result of which at least one of the water vapor-free and the hydrogen-free gas mixes with the combustion gas so as to bring about a partial water vapor pressure of the mixture in the furnace atmosphere of the heat treatment furnace that is less than the defined partial water vapor pressure of the combustion gas.

11. The method as claimed in claim 10, wherein hydrogen is present in the fuel gas with a proportion of at least 20% by volume.

12. The method as claimed in claim 10, wherein hydrogen is present in the fuel gas with a proportion of at least 40% by volume.

13. The method as claimed in claim 10, wherein hydrogen is present in the fuel gas with a proportion of at least 60% by volume.

14. The method as claimed in claim 10, wherein hydrogen is present in the fuel gas with a proportion of at least 80% by volume.

15. The method as claimed in claim 10, wherein hydrogen is present in the fuel gas with a proportion of at least 98% by volume.

16. The method as claimed in claim 15, wherein the at least one of the water vapor-free and the hydrogen-free gas is heated prior to the flooding of the heat treatment furnace.

17. The method as claimed in claim 16, wherein the heating is effected to a temperature corresponding to the temperature of the combustion gas +/−300° C.

18. The method as claimed in either of claim 16, wherein an offgas removed from the heat treatment furnace is used partly or completely for heating of the water vapor-free and/or hydrogen-free gas.

19. The method as claimed in either of claim 17, wherein an offgas removed from the heat treatment furnace is used partly or completely for heating of the water vapor-free and/or hydrogen-free gas.
